(19) United States
(12) Patent Application Publication
(10) Pub. No.: US 2020/0351304 A1
(43) Pub. Date: Nov. 5, 2020

(54) MONITORING SYSTEM, MONITORING METHOD, AND MONITORING PROGRAM

(71) Applicant: NIPPON TELEGRAPH AND TELEPHONE CORPORATION, Tokyo (JP)

(72) Inventor: Hiroshi KURAKAMI, Musashino-shi (JP)

(73) Assignee: NIPPON TELEGRAPH AND TELEPHONE CORPORATION, Tokyo (JP)

(21) Appl. No.: 16/962,855

(22) PCT Filed: Feb. 13, 2019
(86) PCT No.: PCT/JP2019/005170

§ 371 Date: Jul. 17, 2020

(30) Foreign Application Priority Data
Feb. 13, 2018 (JP) 2018-023363

(51) Int. Cl. H04L 29/06

(52) U.S. Cl. CPC H04L 63/1483; H04L 63/1458; H04L 63/1425

(57) ABSTRACT

A monitoring device (10) monitors traffic of a network. The monitoring device (10) collects at least one of first information, which is information concerning a first packet transmitted to an address not used in the Internet, and second information, which is information concerning a second packet transmitted to a specific destination set as a decoy. The monitoring device (10) determines, based on information concerning the traffic monitored by the monitoring device (10) and the information collected by monitoring device (10), whether an attack occurs.

### TECHNICAL FIELD

The present invention relates to a monitoring system, a monitoring method, and a monitoring program.

### BACKGROUND ART

In recent years, in IP networks, attacks to the networks represented by a DDoS (Distributed Denial of Service) attack have been increasing in scale and smartness. Importance of network monitoring has been increasing.

As a technique for detecting the DDoS attack, there has been known a technique for monitoring and detecting traffic addressed to an attack destination IP address using flow information output by network devices such as Net Flow, sFlow, and IPFIX (Internet Protocol Flow Information Export) and packets.

For example, there has been known a DDoS attack detection system that monitors, for each destination IP address and for each attack type such as TCP SYN and determines an attack based on a traffic amount. There has been known a device that monitors traffic for each destination IP address based on flow information and detects a DDoS attack (see, for example, Patent Literature 1).

### CITATION LIST

### Patent Literature

Patent Literature 1: Japanese Patent Laid-Open No. 2009-089241

### SUMMARY OF THE INVENTION

### Technical Problem

However, in the conventional techniques, there is a problem in which the DDoS attack cannot be accurately detected. For example, in the conventional techniques, it is sometimes difficult to distinguish concentration of traffic due to a reflection-type DDoS attack and concentration of regular traffic. In such a case, it is conceivable that detection accuracy is deteriorated because, for example, the DDoS attack is overlooked or the regular traffic is determined as traffic due to the DDoS attack.

### Means for Solving the Problem

In order to solve the problems described above and achieve the object, a monitoring system of the present invention includes: a monitoring unit that monitors traffic of a network; a collection unit that collects at least one of first information, which is information concerning a first packet transmitted to an address not used in an Internet, and second information, which is information concerning a second packet transmitted to a specific destination set as a decoy; and a determination unit that determines, based on information concerning the traffic monitored by the monitoring unit and the information collected by collection unit, whether an attack occurs.

### Effects of the Invention

According to the present invention, it is possible to accurately detect a DDoS attack.

### BRIEF DESCRIPTION OF DRAWINGS

FIG. 1 is a diagram showing an example of the configuration of a monitoring system according to a first embodiment.

FIG. 2 is a diagram showing an example of the configuration of a monitoring device according to the first embodiment.

FIG. 3 is a diagram showing an example of a data configuration of attack information according to the first embodiment.

FIG. 4 is a flowchart showing a flow of collection processing of the monitoring device according to the first embodiment.

FIG. 5 is a flowchart showing a flow of collection processing of the monitoring device according to the first embodiment.

FIG. 6 is a flowchart showing a flow of determination processing of the monitoring device according to the first embodiment.

FIG. 7 is a diagram showing an example of a computer that executes a monitoring program.

### DESCRIPTION OF EMBODIMENTS

Embodiments of a monitoring system, a monitoring method, and a monitoring program according to this application are explained in detail below with reference to the drawings. Note that the present invention is not limited by the embodiments explained below.

### Configuration of a First Embodiment

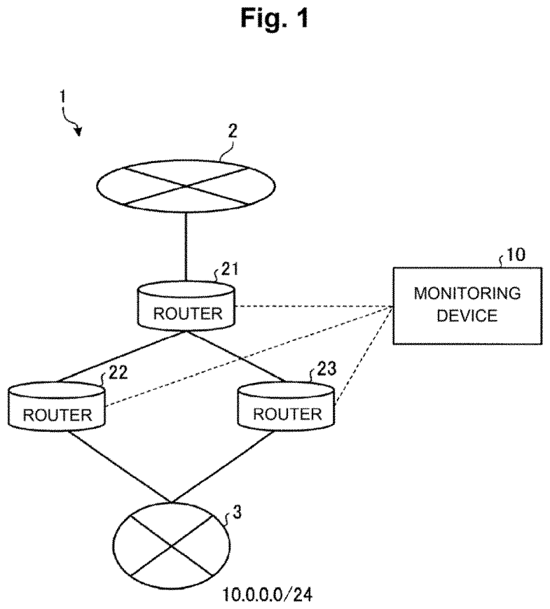

First, the configuration of a monitoring system according to a first embodiment is explained with reference to FIG. 1. FIG. 1 is a diagram showing an example of the configuration of the monitoring system according to the first embodiment. As shown in FIG. 1, a monitoring system 1 includes a monitoring device 10 and routers 21, 22, and 23.

The router 21 is connected to the Internet 2. The routers 22 and 23 are connected to a user network 3. An IP address indicated by 10.0.0.0/24 is allocated to the user network 3.

The router 21 transfers a packet received from the Internet 2 to the routers 22 or 23. The routers 22 and 23 transfer the packet received from the router 21 to a predetermined IP address of the user network 3. The monitoring device 10 acquires information concerning traffic from the router 21 and the routers 22 and 23.

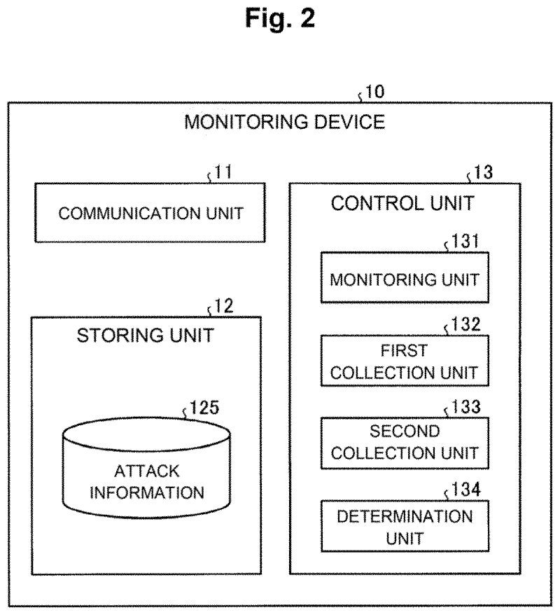

The configuration of the monitoring device 10 is explained with reference to FIG. 2. FIG. 2 is a diagram showing an example of the configuration of a monitoring device according to the first embodiment. As shown in FIG. 2, the monitoring device 10 includes a communication unit 11, a storing unit 12, and a control unit 13.

The communication unit 11 performs data communication between the communication unit 11 and other devices via a network. For example, the communication unit 11 is a NIC (Network Interface Card). The communication unit 11 performs data communication between the communication unit 11 and the routers 21, 22, and 23.

The storing unit 12 is a storage device such as a HDD (Hard Disk Drive), an SSD (Solid State Drive), or an optical disk. Note that the storing unit 12 may be a data-rewritable semiconductor memory such as a RAM (Random Access Memory), a flash memory, or an NVSRAM (Non Volatile Static Random Access Memory). The storing unit 12 stores an OS (Operating System) and various programs executed by the monitoring device 10. Further, the storing unit 12 stores various kinds of information used in the execution of the programs. The storing unit 12 stores attack information 125.

The control unit 13 controls the entire monitoring device 10. The control unit 13 is, for example, an electronic circuit such as a CPU (Central Processing Unit) or an MPU (Micro Processing Unit) or an integrated circuit such as an ASIC (Application Specific Integrated Circuit) or an FPGA (Field Programmable Gate Array). The control unit 13 includes an internal memory for storing programs and control data specifying various processing procedures and executes various kinds of processing using the internal memory. The control unit 13 functions as various processing units according to operation of various programs. For example, the control unit 13 includes a monitoring unit 131, a first collection unit 132, a second collection unit 133, and a determination unit 134. Note that the first collection unit 132 and the second collection unit 133 are examples of the collection unit.

The monitoring unit 131 monitors traffic of the network. The monitoring unit 131 collects traffic information from the router 21 and the routers 22 and 23.

For example, the monitoring unit 131 can collect flow information such as Netflow, sFlow, and IPFIX as the traffic information. The monitoring unit 131 may collect, as the traffic information, copies of packets received by the routers.

For example, the traffic information is information in which various kinds of information are arranged in time series for each of router interfaces, which receive a packet included in traffic, or for each of VLAN IDs. A source IP address, a destination IP address, a protocol, a source port number, a destination port number, a TCP flag, pps (packets per second), and bps (bits per second) of the packet are included in the traffic information.

Further, the monitoring unit 131 detects an attack based on the traffic information. For example, the monitoring unit 131 detects an attack when a predetermined traffic amount exceeds a detection threshold set for each of traffic patterns. For example, the monitoring unit 131 totals up a traffic amount of a TCP/SYN packet for each of destination IP addresses and detects an attack when pps for any one of the destination IP addresses exceeds a detection threshold of 10000 pps or when bps for any one of the destination IP addresses exceeds a detection threshold of 10 Mbps.

When detecting the attack, the monitoring unit 131 provides detection information such as a reception time stamp, an attack type, a detection threshold, a source IP address, a destination IP address, a protocol, a port number, a TCP flag, the number of bytes, and the number of packets to the determination unit 134.

The monitoring device 10 collects at least one of first information, which is information concerning a first packet transmitted to an address not used in the Internet, and second information, which is information concerning a second packet transmitted to a specific destination set as a decoy.

The first collection unit 132 collects the first information. The first collection unit 132 collects information concerning a packet addressed to an IP address not used in the Internet, that is, a packet addressed to a dark network. This is because a backscatter packet is likely to be included in the packet addressed to the dark network.

The backscatter packet is a packet that is, in an attack of a type falsifying a source IP address, a packet transmitted to the falsified IP address by an attack destination site that receives a return request for a packet from an attack source that falsifies the source IP address. At this time, the falsified IP address is sometimes not actually used. Further, since it is considered that a packet is hardly transmitted to an IP address not used in regular communication, it is considered likely that the backscatter packet is included in the packet addressed to the dark network.

The monitoring device 10 can receive the packet addressed to the dark network by performing, with a routing protocol, route advertisement for an IP address not used in the Internet such that the IP address is addressed to the monitoring device 10.

Further, the first collection unit 132 extracts the backscatter packet from the packet addressed to the dark network. For example, the first collection unit 132 extracts an SYN/ACK packet as a backscatter packet to a TCP SYN attack falsifying a source IP address. For example, the first collection unit 132 extracts an RST/ACK packet as a backscatter packet in a TCP attack packet. For example, the first collection unit 132 extracts an ICMP Port Unreachable packet as a backscatter packet for a scan to an out-of-service port.

For example, when the first collection unit 132 extracts an SYN/ACK packet as a backscatter packet, it is seen that a source of the SYN/ACK packet is under TCP SYN attack. For example, when a source IP address of a backscatter packet extracted by the first collection unit 132 is an IP address included in an IP address space in the vicinity such as 10.0.0.1, 10.0.0.2, or 10.0.0.3, it is seen that an attack is performed on three IP addresses included in 10.0.0.0/30.

When a collected backscatter packet is a TCP or UDP packet, the first collection unit 132 provides collection information such as a reception time stamp, a source IP address, a destination IP address, a protocol, a port number, a TCP flag, and the number of bytes to the determination unit 134 as information concerning the backscatter packet.

When a collected backscatter packet is an ICMP packet, the first collection unit 132 provides collection information such as a reception time stamp, a source IP address, a destination IP address, a protocol, a type, a code, and the number of bytes to the determination unit 134 as information concerning the backscatter packet.

In the collection information provided by the first collection unit 132, the source IP address is an IP address of a site that is under attack and the destination IP address is an IP address falsified by an attacker.

The second collection unit 133 collects second information. The second collection unit 133 functions as a decoy and collects information concerning a packet transmitted to a specific IP address set as a decoy. For example, the second collection unit 133 receives a packet, a destination UDP port number of which is 123, among packets transmitted to the decoy.

The second collection unit 133 transmits a response packet to a scan packet among the packets transmitted to the specific IP address set as the decoy and collects information concerning a packet transmitted from a source of the response packet.

That is, in a reflection-type attack, as an example, the second collection unit 133 functions as a reflector of a DNS (Domain Name System) server, an NPT (Network Time Protocol) server, and the like. When responding to all scan packets, since response packets are sometimes involved in a reflection-type attack, the second collection unit 133 may set, for each of transmission destinations to which response packets are transmitted, an upper limit of the number of response packets to be transmitted.

The second collection unit 133 totals up instruction packets, which are transmitted from the transmission destinations of the response packets, for each of sources of the packets. When a totaled value reaches a value equal to or larger than a set threshold within a fixed time, the second collection unit 133 determines that the source is under reflection-type attack and provides collection information such as a reception time stamp, an attack type, a threshold, a source IP address, a destination IP address, a protocol, a port number, the number of bytes, and the number of packets to the determination unit 134.

Note that, when a received instruction packet is a packet used in a reflection-type attack such as an NTP monlist request packet, the second collection unit 133 may determine that a source is under attack.

The determination unit 134 determines, based on information concerning the traffic monitored by the monitoring unit 131 and the information collected by at least one of the first collection unit 132 and the second collection unit 133, whether an attack has occurred.

In other words, the determination unit 134 compares the detection information provided from the monitoring unit 131 and the collection information provided from the first collection unit 132 and the second collection unit 133 and, when a detection result indicated by the detection information can be supported by the collection information, determines that a detection result by the monitoring unit 131 is highly accurate.

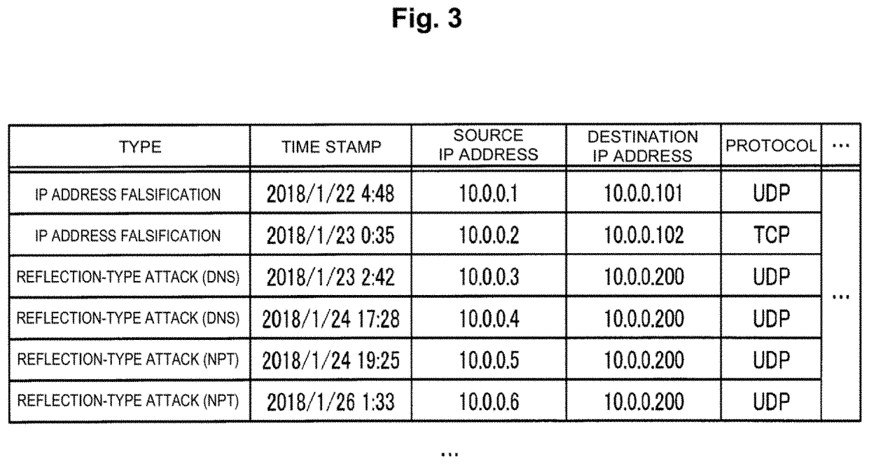

When determining that the monitoring unit 131 detects an attack at high accuracy, the determination unit 134 stores the attack information 125 based on the collection information and the detection information in the storing unit 12. FIG. 3 is a diagram showing an example of a data configuration of attack information according to the first embodiment.

For example, the determination unit 134 compares the collection information provided from the first collection unit 132 and the detection information provided from the monitoring unit 131. In the following case, the determination unit 134 determines that the monitoring unit 131 detects, at high accuracy, an attack of a type falsifying a source IP address: when there is information indicating that reception time stamps are in the same time period and a source IP address of the collection information provided from the first collection unit 132 is the same as a destination IP address of the detection information provided from the monitoring unit 131.

For example, as shown in FIG. 3, when determining that information is highly accurate according to a detection result explained below, the determination unit 134 stores the information in the storing unit 12 as the attack information 125. In FIG. 3, a detection result of an attack case that occurs at 2018 Jan. 22 4:48 shows that traffic, a source IP address and a destination IP address of which are respectively 10.0.0.1 and 1.0.0.0.101 and a protocol of which is UDP, is traffic due to an IP address falsifying-type attack.

For example, the determination unit 134 compares the collection information provided from the second collection unit 133 and the detection information provided from the monitoring unit 131. In the following case, the determination unit 134 determines that the monitoring unit 131 detects a reflection-type attack at high accuracy: when there is information indicating that reception time stamps of the collection information provided from the second collection unit 133 and the detection information provided from the monitoring unit 131 are in the same time period and a source IP address of the collection information provided from the second collection unit 133 is the same as a destination IP address of the detection information provided from the monitoring unit 131.

For example, as shown in FIG. 3, when determining that information is highly accurate according to a detection result explained below, the determination unit 134 stores the information in the storing unit 12 as the attack information 125. In FIG. 3, a detection result of an attack case that occurs at 2018 Jan. 23 2:42 shows that traffic, a source IP address and a destination IP address of which are respectively 10.0.0.3 and 1.0.0.0.200 and a protocol of which is UDP, is traffic due to a reflection-type attack targeting a DNS server.

Since a plurality of IP addresses under attack can be detected in the first collection unit 132 and the second collection unit 133, the monitoring device 10 collects at least one of the first information and the second information and uses the information for determination of an attack to a plurality of IP addresses for the same network. The determination unit 134 determines, based on an amount of traffic monitored by the monitoring unit 131, that is, an amount of traffic addressed to a plurality of source IP addresses indicated by the first information and the second information, whether an attack has occurred.

In order to congest access lines to one network, an attacker of a DDoS attack sometimes disperses accesses to a plurality of IP accesses such as 10.0.0.1, 10.0.0.2, and 10.0.0.3 in the same network. In such a case, even if an attack has occurred, it is likely that a traffic amount in destination IP address units does not reach a detection threshold set by the monitoring unit 131.

Therefore, the determination unit 134 can cause the monitoring unit 131 to total up traffic amounts of a plurality of IP addresses and execute detection by a threshold based on a result of the totaling and can perform determination based on the result.

### Processing in the First Embodiment

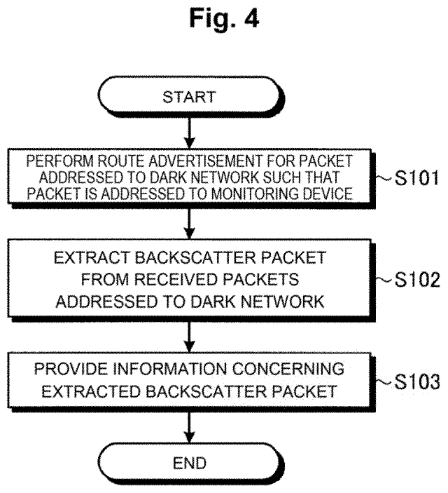

Collection processing and determination processing by the monitoring device 10 are explained with reference to FIGS. 4 to 6. For example, collection processing by the first collection unit 132 and the second collection unit 133 is performed and, after kinds of collection information are provided, determination processing by the determination unit 134 is performed.

The collection processing by the first collection unit 132 is explained with reference to FIG. 4. FIG. 4 is a flowchart showing a flow of collection processing of the monitoring device according to the first embodiment. As shown in FIG. 4, first, the first collection unit 132 preforms route advertisement for a packet addressed to a dark network such that the packet is addressed to the monitoring device 10 (step S101). The first collection unit 132 extracts a backscatter packet from received packets addressed to the dark network (step S102). The first collection unit 132 provides information concerning the backscatter packet to the determination unit 134 (step S103).

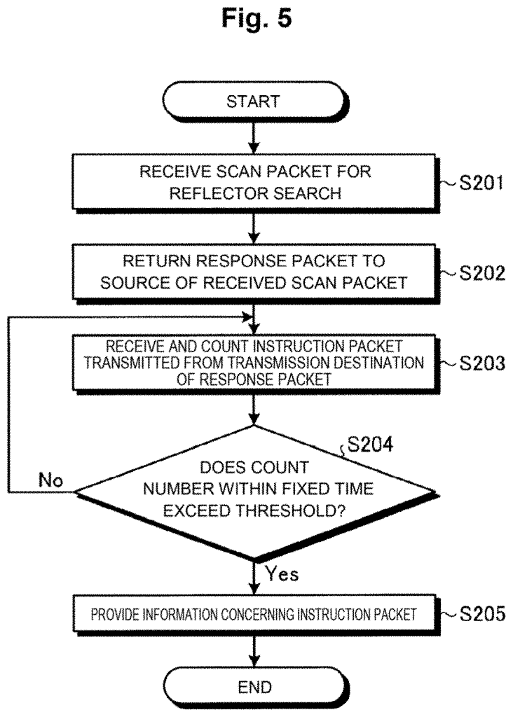

Collection processing by the second collection unit 133 is explained with reference to FIG. 5. FIG. 5 is a flowchart showing a flow of collection processing of the monitoring device according to the first embodiment. As shown in FIG. 5, first, the second collection unit 133 receives a scan packet for reflector search (step S201). Subsequently, the second collection unit 133 returns a response packet to a source of the received scan packet (step S202). The second collection unit 133 receives and counts an instruction packet transmitted from a transmission destination of the response packet (step S203).

When a count number within a fixed time exceeds a threshold (Yes in step S204), the second collection unit 133 determines that a reflection-type attack has occurred and provides information concerning instruction packets to the determination unit 134 (step S205). On the other hand, when the count number within the fixed time does not exceed the threshold (No in step S204), the second collection unit 133 returns to step S203 and further continues the count.

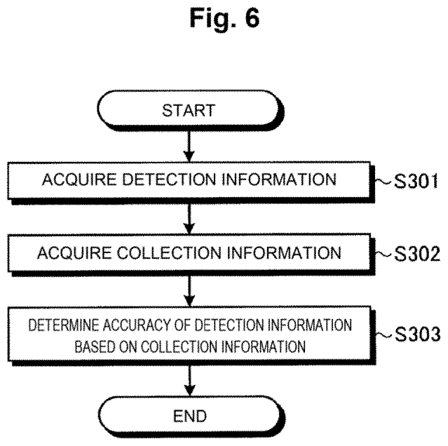

Determination processing by the determination unit 134 is explained with reference to FIG. 6. FIG. 6 is a flowchart showing a flow of determination processing of the monitoring device according to the first embodiment. As shown in FIG. 6, the determination unit 134 acquires detection information provided from the monitoring unit 131 (step S301). The determination unit 134 acquires collection information provided from the first collection unit 132 and the second collection unit 133 (step S302). The determination unit 134 determines, based on the collection information, whether the detection information is highly accurate and determines whether an attack has actually occurred (step S303).

### Effects in the First Embodiment

The monitoring device 10 monitors traffic of a network. The monitoring device 10 collects at least one of first information, which is information concerning a first packet transmitted to an address not used in the Internet, and second information, which is information concerning a second packet transmitted to a specific destination set as a decoy. The monitoring device 10 determines, based on information concerning the traffic monitored by the monitoring device 10 and the information collected by the monitoring device 10, whether an attack has occurred. In this way, in this embodiment, it is possible to determine occurrence of a DDoS attack considering not only an aspect of traffic but also an occurrence situation of at least one of a backscatter packet and a reflection attack. Therefore, according to this embodiment, it is possible to accurately detect the DDoS attack.

In detection based on only traffic, an attack sometimes cannot be detected for a specific IP address in a network. On the other hand, according to this embodiment, it is possible to improve detection accuracy for an attack for a specific IP address of a source or the like of a backscatter packet.

The monitoring device 10 collects, as the first information, information concerning a response packet to an attack packet falsifying a source IP address received as a first packet. Consequently, it is possible to specify an IP address of a site that is under IP address falsifying-type attack and determine a level of detection accuracy for the IP address falsifying-type attack based on traffic.

The monitoring device 10 collects, as the second information, information concerning a reflection attack packet received as a second packet. Consequently, it is possible to specify an IP address of a site that is under reflection-type attack and determine a level of detection accuracy for the reflection-type attack based on traffic.

The monitoring device 10 compares the collection information collected by the first collection unit 132 and the detection information provided from the monitoring unit 131. When there is information indicating that reception time stamps are in the same time period and a source IP address of the collection information provided from the first collection unit 132 is the same as a destination IP address of the detection information provided from the monitoring unit 131, the monitoring device 10 determines that an attack of a type falsifying the source IP address is detected. Consequently, it is possible to improve detection accuracy for an attack of a type falsifying an IP address.

The monitoring device 10 compares the collection information collected by the second collection unit 133 and the detection information provided from the monitoring unit 131. When there is information indicating that reception time stamps are in the same time period and a source IP address of the collection information provided from the second collection unit 133 is the same as a destination IP address of the detection information provided from the monitoring unit 131, the monitoring device 10 determines that a reflection-type attack is detected. Consequently, it is possible to improve detection accuracy for the reflection-type attack.

The monitoring device 10 collects at least one of the first information and the second information for respective packets, sources of which are a plurality of different IP addresses. The monitoring device 10 determines, based on a total of amounts of traffic monitored by the monitoring device 10, that is, amounts of traffic addressed to a plurality of addresses, whether an attack has occurred. Consequently, it is possible to detect a DDoS attack that disperses accesses to a plurality of IP addresses in the same network.

### System Configuration and the Like

The illustrated components of the devices are functionally conceptual and are not always required to be physically configured as shown illustrated. That is, specific forms of dispersion and integration of the devices are not limited to the illustrated ones. All or a part of the devices can be functionally or physically dispersed or integrated in any units according to various loads, states of use, and the like. Further, all or any part of the processing functions performed in the devices can be realized by a CPU and programs analyzed and executed by the CPU or can be realized as hardware by a wired logic.

Among the kinds of processing explained in this embodiment, all or a part of the processing explained as being automatically performed can also be manually performed or all or a part of the processing explained as being manually performed can also be automatically performed by a publicly-known method. Besides, information including processing procedures, control procedures, specific names, various data, and parameters explained and shown in the document and the drawings can be optionally changed unless specifically described otherwise.

### Programs

As an embodiment, the monitoring device 10 can be implemented by causing a desired computer to install, as package software or online software, a monitoring program for executing the monitoring explained above. For example, it is possible to cause an information processing device to function as the monitoring device 10 by causing the information processing device to execute the monitoring program. A desktop or notebook personal computer is included in the information processing device referred to herein. Besides, a mobile communication terminal such as a smartphone, a cellular phone, or a PHS (Personal Handyphone System), a slate terminal such as a PDA (Personal Digital Assistant), and the like are included in the category of the information processing device.

The monitoring device 10 can also be implemented as a monitoring server device that sets, as a client, a terminal device used by the user and provides a service concerning the monitoring to the client. For example, the monitoring server device is implemented as a server device that provides a monitoring service for receiving a copy of flow information and a packet as an input and outputting a determination result. In this case, the monitoring server device may be implemented as a Web server or may be implemented as the cloud that provides, through outsourcing, a service concerning the monitoring explained above.

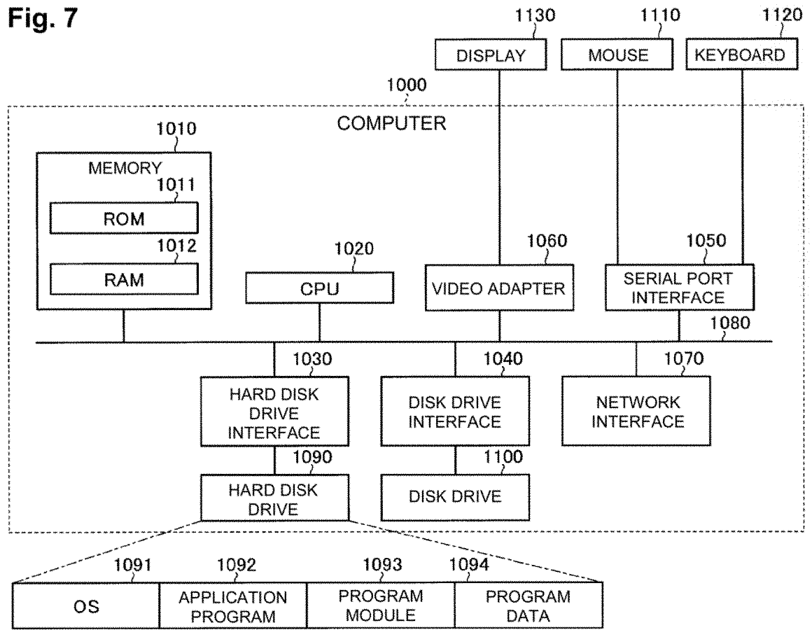

FIG. 7 is a diagram showing an example of a computer that executes a monitoring program. A computer 1000 includes, for example, a memory 1010 and a CPU 1020. The computer 1000 includes a hard disk drive interface 1030, a disk drive interface 1040, a serial port interface 1050, a video adapter 1060, and a network interface 1070. These units are connected by a bus 1080.

The memory 1010 includes a ROM (Read Only Memory) 1011 and a RAM 1012. The ROM 1011 stores a boot program such as a BIOS (Basic Input Output System). The hard disk drive interface 1030 is connected to a hard disk drive 1090. The disk drive interface 1040 is connected to a disk drive 1100. For example, a detachable storage medium such as a magnetic disk or an optical disk is inserted into the disk drive 1100. The serial port interface 1050 is connected to, for example, a mouse 1110 and a keyboard 1120. The video adapter 1060 is connected to, for example, a display 1130.

The hard disk drive 1090 stores, for example, an OS 1091, an application program 1092, a program module 1093, and a program data 1094. That is, a program specifying the processing of the monitoring device 10 is implemented as the program module 1093 in which a code executable by a computer is described. The program module 1093 is stored in, for example, the hard disk drive 1090. For example, the program module 1093 for executing the same processing as the processing of the functional configuration in the monitoring device 10 is stored in the hard disk drive 1090. Note that the hard disk drive 1090 may be substituted by an SSD.

Setting data used in the processing in the embodiment explained above is stored in, for example, the memory 1010 and the hard disk drive 1090 as the program data 1094. The CPU 1020 reads out the program module 1093 and the program data 1094 stored in the memory 1010 and the hard disk drive 1090 to the RAM 1012 according to necessity and executes the processing in the embodiment explained above.

Note that the program module 1093 and the program data 1094 is not limited to the storage in the hard disk drive 1090 and may be stored in, for example, a detachable storage medium and read out by the CPU 1020 via the disk drive 1100 or the like. Alternatively, the program module 1093 and the program data 1094 may be stored in another computer connected via a network (a LAN (Local Area Network), a WAN (Wide Area Network), or the like). The program module 1093 and the program data 1094 may be read out from the other computer by the CPU 1020 via the network interface 1070.

### REFERENCE SIGNS LIST

1 Monitoring system
2 Internet
3 User network
10 Monitoring device
11 Communication unit
12 Storing unit
13 Control unit
21, 22, 23 Router
125 Attack information
131 Monitoring unit
132 First collection unit
133 Second collection unit
134 Determination unit

1. A monitoring system comprising:
monitoring circuitry that monitors traffic of a network;
collection circuitry that collects at least one of first information, which is information concerning a first packet transmitted to an address not used in an Internet, and second information, which is information concerning a second packet transmitted to a specific destination set as a decoy; and
determination circuitry that determines, based on information concerning the traffic monitored by the monitoring circuitry and the information collected by collection circuitry, whether an attack occurs.

2. The monitoring system according to claim 1, wherein the collection circuitry collects, as the first information, information concerning a response packet to an attack packet falsifying a source IP address received as the first packet.

3. The monitoring system according to claim 1, wherein the collection circuitry collects, as the second information, information concerning a reflection attack packet received as the second packet.

4. The monitoring system according to claim 1, wherein the determination circuitry compares the first information collected by the collection circuitry and the traffic information monitored by the monitoring circuitry and, when reception times of the first information and the traffic information are in a same time period and a source IP address of the first information is same as a destination IP address of the traffic information, determines that an attack falsifying the source IP address is detected.

5. The monitoring system according to claim 1, wherein the determination circuitry compares the second information collected by the collection circuitry and the traffic information monitored by the monitoring circuitry and, when reception times of the second information and the traffic information are in a same time period and a source IP address of the second information is same as a destination IP address of the traffic information, determines that a reflection attack is detected.

6. The monitoring system according to claim 1, wherein
the collection circuitry collects, for each of packets, sources of which are a plurality of different addresses in a same network, at least one of the first information and the second information and informs the monitoring circuitry of the collected information, and
the determination circuitry determines, based on a total of amounts of the traffic monitored by the monitoring circuitry, that is, amounts of traffic addressed to the plurality of addresses, whether an attack occurs.

7. A monitoring method executed by a monitoring system, the monitoring method comprising:
a monitoring step of monitoring traffic of a network;
a collecting step of collecting at least one of first information, which is information concerning a first packet transmitted to an address not used in an Internet, and second information, which is information concerning a second packet transmitted to a specific destination set as a decoy; and
a determining step of determining, based on information concerning the traffic monitored by the monitoring step and the information collected by collecting step, whether an attack occurs.

8. A monitoring program for causing a computer to execute:
a monitoring step of monitoring traffic of a network;
a collecting step of collecting at least one of first information, which is information concerning a first packet transmitted to an address not used in an Internet, and second information, which is information concerning a second packet transmitted to a specific destination set as a decoy; and
a determining step of determining, based on information concerning the traffic monitored by the monitoring step and the information collected by collecting step, whether an attack occurs.
